(19) United States
(12) Patent Application Publication
(10) Pub. No.: US 2006/0232243 A1
(43) Pub. Date: Oct. 19, 2006

(54) Electrical appliance for use with batteries

(76) Inventors: David Anthony Dabdoub, Kenner, LA (US); Kelvin B. Belle, Creve Coeur, MO (US); Peter Fischer Hoffman, Avon, OH (US); Anne M. Gierse, Ballwin, MO (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 11/104,760

(22) Filed: Apr. 13, 2005

(51) Int. Cl. H02J 7/00

(52) U.S. Cl. 320/128

(57) ABSTRACT

An electrical appliance such as a battery charger includes a main body portion and a movable body portion. The apparatus includes a first cavity for receiving batteries. The movable body portion opens to expose a second cavity for receiving batteries. Each of the cavities includes battery receiving regions or bays. Each bay selectively receives a first battery having a relatively larger radial dimension or a plurality of batteries having a relatively smaller radial dimension. The bays can receive various battery sizes, such as AAA, AA, C, and D size batteries. One or more of the bays can receive a generally rectangular 9 volt battery.

### BACKGROUND

The present application generally relates to electrical appliances using batteries, and more particularly to battery chargers.

Rechargeable (secondary) batteries, such as nickel-metal hydride (Ni-MH) and nickel-cadmium (Ni-Cd) electrical cells, are generally designed to be recharged by applying an electrical charging current to the positive and negative battery terminals. To perform battery recharging, a battery charger is employed. The charger generally includes electrical charge contact terminals configured to contact the positive and negative battery terminals of a battery to provide an electrical current charging path. Conventional battery chargers are known to charge an individual battery or a plurality of batteries simultaneously.

Many conventional battery chargers are large in size and therefore consume a significant amount of space. Such battery chargers typically have a main housing containing electrical charging circuitry and a battery holding compartment extending from the main housing. The large size chargers are tedious for users to transport, add to inefficiencies in shipping and handling, and sometimes receive less preferential placement in point of sale displays. Accordingly, there is a need for a more space efficient battery charger.

In order to reduce the size of the charger, some battery chargers have been provided with collapsible-type housings which enable a user to collapse the battery charger into a reduced volume space. For example, one such charger includes a housing structure having a first upstanding wall and a second upstanding wall which is generally parallel to the first. A sliding tray is movable between a first position in which the first and second walls are adjacent to each other and a second position in which the first and second walls are spaced apart. In the first position, the charger does not accept batteries for charging. In the second position, the tray is configured to hold one or more batteries for charging. While such a charger has proven to be compact, it is nonetheless desirable to produce a battery charger having still additional flexibility.

It is also desirable to produce a battery charger which can be used to charge batteries of different sizes. To this end, battery chargers have also included separate charging bays, each bay receiving a battery having a particular size. Still other battery chargers have included bays which can be can be configured to accept a battery of varying sizes. Again, however, it remains desirable to produce a battery charger which is space efficient yet also provides additional flexibility in charging batteries of various sizes.

### SUMMARY

Aspects of the present invention address these matters, and others.

According to a first aspect of the present invention, an apparatus includes battery charging circuitry, a first region, and a second region. The first region is adapted to selectively receive one of a first generally cylindrical battery having a radial dimension and a first plurality of generally cylindrical batteries having radial dimensions less than the radial dimension of the first battery. The first plurality of batteries are received in positions which are radially offset from the position of the first battery. The second region is adapted to selectively receive one of a second generally cylindrical battery having a radial dimension and a second plurality of generally cylindrical batteries having radial dimensions less than the radial dimension of the second battery. The second plurality of batteries are received in positions which are radially offset from the position of the second battery. The apparatus also includes contacts in electrical communication with the battery charging circuitry and adapted to make electrical contact with the batteries selectively received in the first region, and contacts in electrical communication with the battery charging circuitry and adapted to make electrical contact with the batteries selectively received in the second region.

According to a more limited aspect of the invention, the second region is disposed longitudinally in relation to the first region. The apparatus also includes a third region disposed radially in relation to the first region, and a fourth region. The third region is adapted to selectively receive one of a third generally cylindrical battery having a radial dimension and a third plurality of generally cylindrical batteries having radial dimensions less than the radial dimension of the third battery. The fourth region is adapted to selectively receive one of a fourth generally cylindrical battery having a radial dimension and a fourth plurality of generally cylindrical batteries having radial dimensions less than the radial dimension of the fourth battery. The apparatus also includes contacts in electrical communication with the battery charging circuitry and adapted to make electrical contact with the batteries selectively received in the third region, and contacts in electrical communication with the battery charging circuitry and adapted to make electrical contact with the batteries selectively received in the fourth region.

The second region may be disposed radially in relation to the first region.

The first region is adapted to selectively receive one of a C size battery, a plurality of AA size batteries, or a plurality of AAA size batteries. The first and second regions may each be adapted to selectively receive one of a C size battery, a D size battery, two AA size batteries, or two AAA size batteries.

According to another more limited aspect, the first region may be adapted to selectively receive a generally rectangular 9 volt battery. The 9 volt battery may be received with its major axis substantially perpendicular to the longitudinal axis of the first battery.

According to another more limited aspect of the present invention, the contacts adapted to make electrical contact with batteries selectively received in the first region include longitudinally spaced contacts. The longitudinal spacing of the contacts is adjustable to make electrical contact with batteries having at least first, second, and third longitudinal dimensions. The longitudinal spacing of the contacts may be slidably adjustable.

According to a yet more limited aspect, the longitudinal spacing of the contacts is adjustable to make electrical contact with batteries having at least first, second, and third longitudinal dimensions. The longitudinal spacing of the contacts adapted to make electrical contact with batteries selectively received in the first region may be adjustable independently from the longitudinal spacing of the contacts adapted to make electrical contact with batteries selectively received in the second region.

The apparatus may be selectively configurable in a first configuration wherein the second region is adapted to receive one or more batteries for charging and a second configuration wherein the second region is substantially non-existent.

The first region may be adapted to selectively receive one of a C size battery, a plurality of AA size batteries, a plurality of AAA size batteries, or a generally rectangular 9 volt battery.

According to another aspect of the present invention, the apparatus includes a first set of longitudinally spaced electrical contacts. The contacts are adapted to selectively make electrical contact with the positive and negative terminals of one of a first generally cylindrical battery having a radial dimension and a longitudinal dimension and a first plurality of generally cylindrical batteries having radial dimensions less than the radial dimension of the first battery and longitudinal dimensions different from the longitudinal dimension of the first battery. The first set of contacts receives the first plurality of batteries in positions which are radially offset from the position of the first battery, and the longitudinal spacing of the first set of electrical contacts is adjustable.

According to a more limited aspect of the invention, the first battery is a C size battery and the first plurality of batteries are AA or AAA size batteries. The longitudinal spacing of the first set of contacts is adjustable to make electrical contact with C, AA, and AAA size batteries. The first plurality may equal 2.

The first battery may include a C size or a D size battery and the first plurality of batteries may include AA or AAA size batteries, and the longitudinal spacing of the contacts may be selectively adjustable to make electrical contact with the terminals of C, D, AA, and AAA size batteries.

According to another limited aspect of the present invention, the first plurality of batteries are connected electrically in series.

According to another more limited aspect, the first set of longitudinally spaced electrical contacts includes a first contact and a second contact. The apparatus also includes a first support. The second contact is supported by the first support, and the first support is adjustable so as to vary the longitudinal spacing of the first and second contacts. The first support may be slidably adjustable. The first set of longitudinally spaced electrical contacts may include a third contact supported by the first support. The first support may be adjustable so as to vary the longitudinal spacing between the first contact and the second and third contacts.

According to another yet more limited aspect of the invention, the apparatus also includes a second set of longitudinally spaced electrical contacts adapted to selectively make electrical contact with the positive and negative terminals of one of a second generally cylindrical battery having a radial dimension and a longitudinal dimension and a second plurality of generally cylindrical batteries having radial dimensions less than the radial dimension of the second battery and longitudinal dimensions different from the longitudinal dimension of the second battery. The second set of contacts receives the second plurality of batteries in positions radially offset from the position of the second battery, and the longitudinal spacing of the second set of electrical contacts is adjustable.

The second set of contacts may be disposed generally radially in relation to the first set of contacts.

According to another still more limited aspect of the present invention, the second set of longitudinally spaced electrical contacts includes a fourth contact and a fifth contact, and the apparatus also includes a second support. The fifth contact is supported by the second support, and the second support is adjustable so as to vary the longitudinal spacing between the fourth and fifth contacts.

The second set of longitudinally spaced electrical contacts may also include a fourth contact and a fifth contact, with the fifth contact supported by the first support. The first support may be adjustable so as to vary the longitudinal spacing between the first and fourth contacts and the second and fifth contacts.

The apparatus may also include battery charging circuitry operatively connected to the first set of longitudinally spaced contacts.

According to another aspect of the present invention, an apparatus includes at least a first electrical contact for selectively making electrical contact with a first terminal of one of a first battery having a radial dimension and a longitudinal dimension, and each of a first plurality of batteries having a radial dimension less than the radial dimension of the first battery and a longitudinal dimension different from that of the first battery. The apparatus also includes at least a second electrical contact for selectively making electrical contact with the second terminal of one of the first battery and each of the first plurality of batteries. The contacts receive the first plurality of batteries in positions which are generally radially offset from the position of the first battery. The apparatus also includes means for supporting the at least a second contact for longitudinal motion in relation to the at least a first contact. The spacing of the contacts is adjustable between a first position for making electrical contact with the terminals of the first battery and a second position for making electrical contact with the terminals of the first plurality of batteries.

The contacts may be adjustable to a third position in which the distance between the contacts is insufficient to receive a battery for electrical contact therebetween.

According to a more limited aspect of the invention, the means for supporting may be slidably movable in the longitudinal direction.

According to another more limited aspect of the invention, the apparatus includes a main body portion. The means for supporting includes a moving body portion.

According to another aspect of the present invention, an apparatus includes a structure which defines a battery receiving region adapted to selectively receive either a plurality of AA size batteries, a plurality of AAA size batteries, or a first battery having a radial dimension larger than the radial dimension of the AA batteries. The first battery is received in a position which is radially offset from a position of a AA battery received in the battery receiving region. The apparatus also includes contacts adapted to make electrical contact with the batteries selectively received in the battery receiving region.

According to a more limited aspect, the battery receiving region is adapted to selectively receive two AA size batteries, two AAA size batteries, a C size battery, or a D size battery. The battery receiving region may also receive a generally rectangular 9 volt battery.

According to another aspect of the present invention, an apparatus includes a first body portion configured to receive a first generally cylindrical battery. The first body portion includes a first wall. The apparatus also includes a first pair of longitudinally spaced contacts adapted to make electrical contact with the first battery and a movable body portion having a second wall. The movable body portion is movable between a first position and a second position. In the first position, the first and second walls are adjacent to each other. In the second position, the first and second walls are spaced from one other, and the moveable body portion is configured to receive a second generally cylindrical battery. The apparatus also includes a second pair of contacts adapted to make electrical contact with the second battery. The second pair of contacts includes a first contact supported by the first wall and a second contact supported by the second wall.

According to a more limited aspect of the invention, the second battery is received longitudinally in relation to the first battery.

The body portion may be configured to receive a third generally cylindrical battery, with the third battery received radially in relation to the first battery. The apparatus may also include a third pair of contacts adapted to make electrical contact with the third battery.

According to a yet more limited aspect of the present invention, the movable body portion, when disposed in the second position, is configured to receive a fourth generally cylindrical battery. The fourth battery is received radially in relation to the third battery. The apparatus also includes a fourth pair of contacts adapted to make electrical contact with the fourth battery.

The apparatus may also include a battery support disposed near the second wall.

According to another aspect of the present invention, an apparatus includes first and second housing portions. The first housing portion defines a first battery holding region adapted to hold a first battery. The second housing portion is extendable in relation to the first housing portion so as to define a second battery holding region adapted to hold a second battery. The second housing portion is also retractable in relation to the first housing portion so that the second battery holding region is substantially non-existent. The apparatus also includes a first contact adapted to make electrical contact with the first battery, and a first contact adapted to make electrical contact with the second battery.

According to a more limited aspect of the invention, the second housing portion is telescopically extendable.

Still other aspects of the present invention will be understood by those skilled in the art upon reading and understanding the attached description.

### BRIEF DESCRIPTION OF THE DRAWINGS

FIG. 1 is a top view of a battery charger.

FIG. 2 is a side view of a battery charger.

FIG. 3 is a perspective view of a battery charger.

FIG. 4 is a perspective view of a battery charger.

FIG. 5 is a top view of a first cavity of a battery charger.

FIG. 6 is a sectional view of a first cavity of a battery charger as shown in FIG. 5.

FIG. 7 is a sectional view of a first cavity of a battery charger as shown in FIG. 5.

FIG. 8 is a top view of a second cavity of a battery charger.

FIG. 9 is a sectional view of a second cavity of a battery charger as shown in FIG. 8.

FIG. 10 is a sectional view of a second cavity of a battery charger as shown in FIG. 8.

FIG. 11 is a block diagram of the charging circuitry of a battery charger.

FIG. 12 is a sectional view of a first cavity of a battery charger.

FIG. 13 is a sectional view of a first cavity of a battery charger.

### DETAILED DESCRIPTION

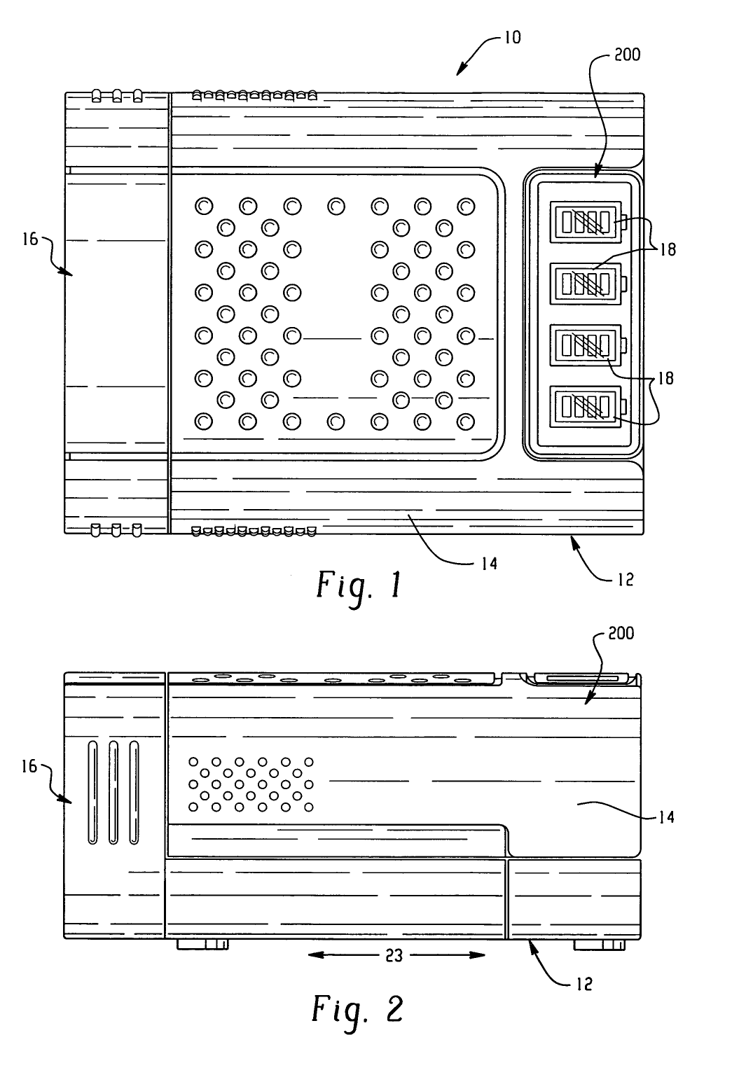

With reference to FIGS. 1, 2, and 3, an electrical appliance such as a battery charger 10 includes a main body 12, a cover 14, and a movable body portion 16. The cover 14 is mounted to the main body 12 for pivotal motion between open and closed positions. The cover 14 opens to expose a first or main cavity 20. In the illustrated embodiment, the main cavity 20 includes first and second charging bays 28, 30. As will be described in more detail below, each charging bay 28, 30 is configured to receive one or more generally cylindrical batteries 22 as well as a standard 9 volt battery having a generally rectangular shape.

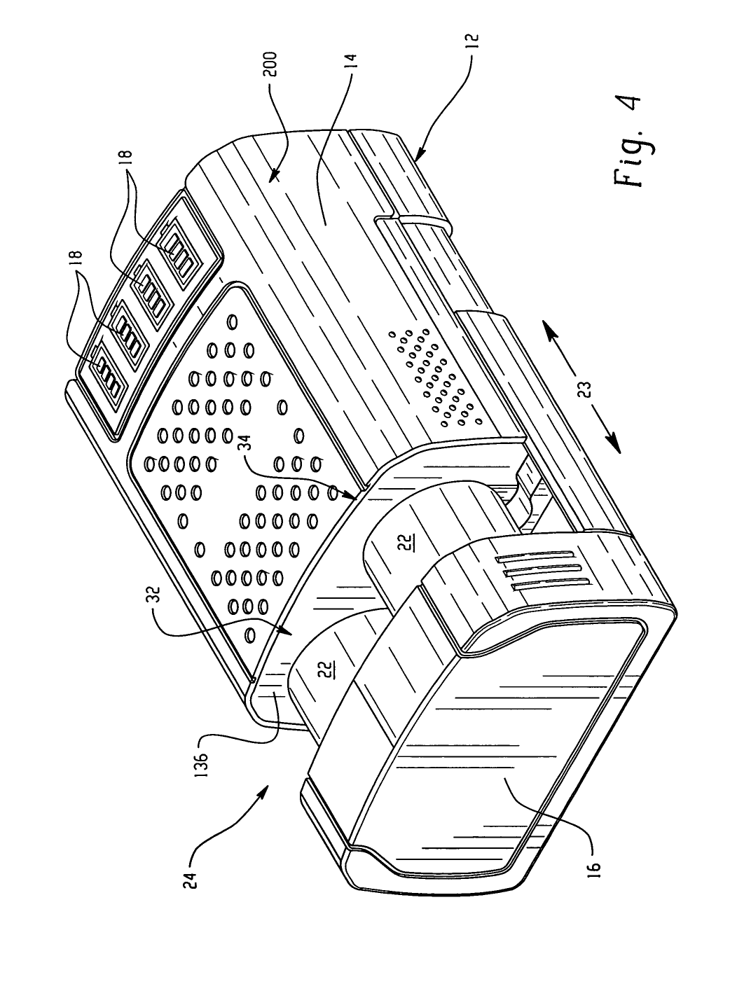

With continuing reference to FIGS. 1, 2, and 3 and further reference to FIG. 4, the movable body portion 16 is mounted to the main body 12 for telescopic linear movement along axis 23. The movable body portion 16 extends to expose a second or auxiliary cavity 24. In the illustrated embodiment, the second cavity 24 includes third and fourth charging bays 32, 34. As with the first and second bays 28, 30, the third and fourth bays 32, 34 are each configured to receive one or more generally cylindrical batteries 22. In a compressed or retracted position, the main and movable body portions 12, 16 overlap, and the second or auxiliary cavity portion is substantially non-existent.

The main body 12 also contains electrical charging circuitry which supplies an electrical current to the batteries to be recharged. Human readable indicators 18 such as light emitting diodes indicate the status of the charger. In the illustrated embodiment, separate indicators are provided to indicate the status of the each of the charging bays 28, 30, 32, 34.

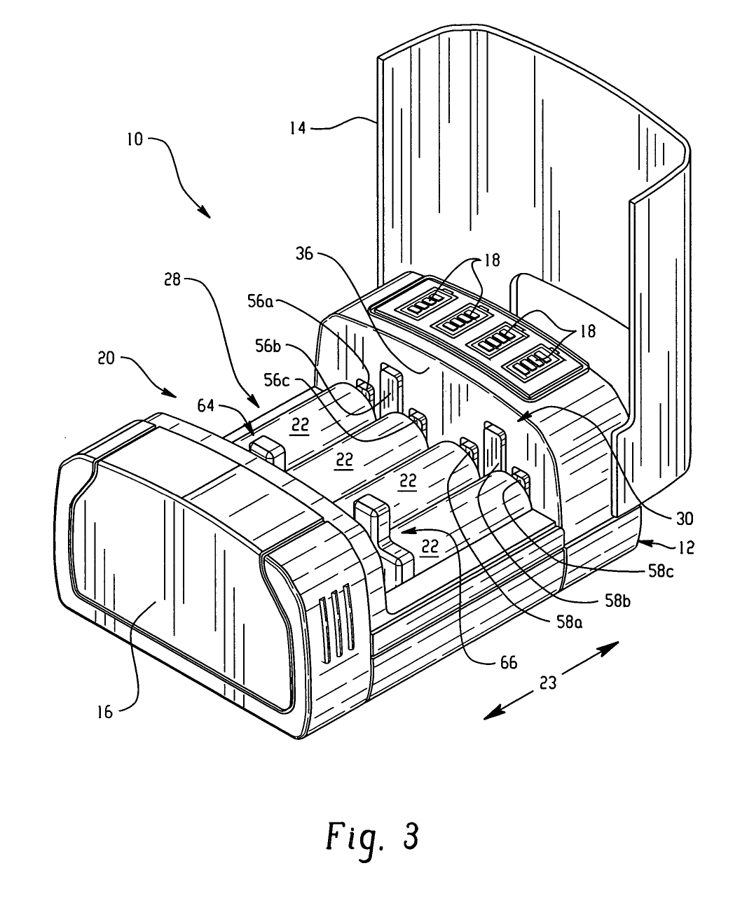

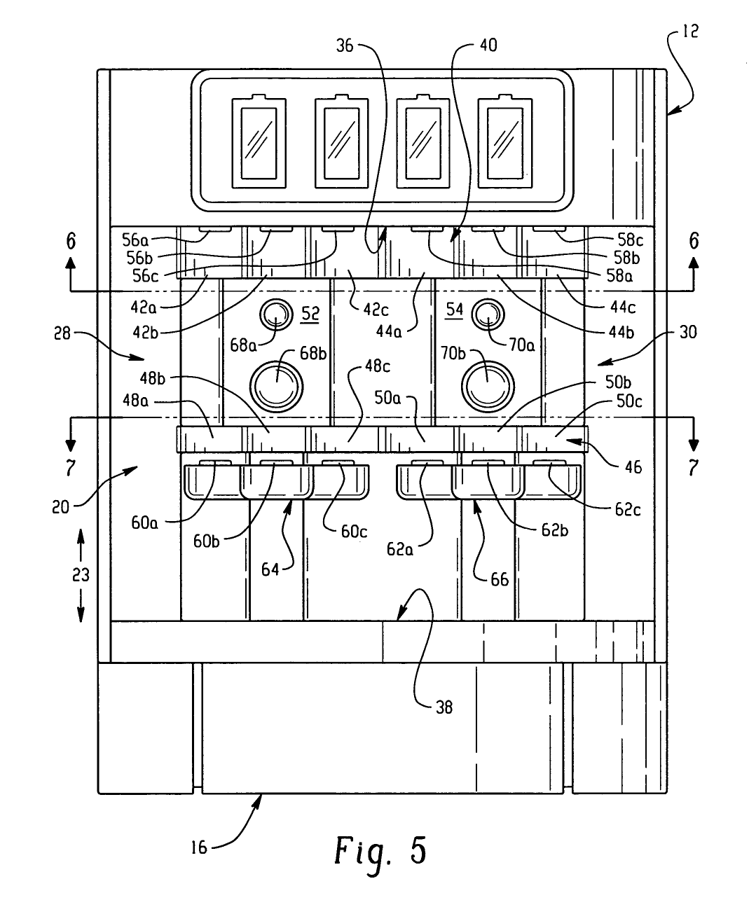

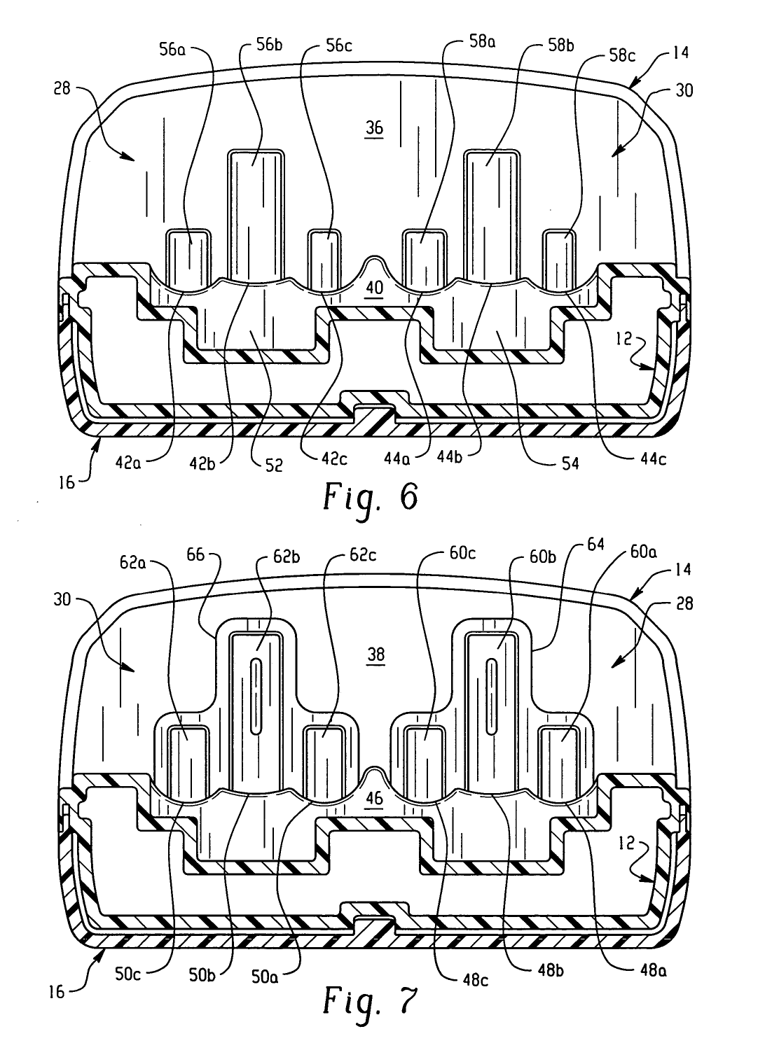

With continuing reference to FIGS. 3 and further reference to FIGS. 5 and 6, the first cavity 20 is shown in greater detail. As noted above, the first cavity 20 includes first and second charging bays 28, 30. The first and second charging bays 28, 30 are located generally radially in relation to each other.

The first cavity 20 includes first and second end walls 36, 38. Disposed near the first end wall 36 is a first battery support 40. A second battery support 46 is longitudinally spaced from the first battery support 40. The first and second battery supports 40, 46 include respective curved battery supports 42a, 42b, 42c and 48a, 48b, 48c associated with the first charging bay 28. The first and second battery supports 40, 46 also include respective curved battery supports 44a, 44b, 44c and 50a, 50b, 50c associated with the second charging bay 30.

The radii of the outer curved battery supports 42a, 42c, 48a, 48c, 44a, 44c, 50a, 50c are selected to support batteries having a relatively smaller radial dimension, for example standard AA and AAA size single cell batteries. The radii of the more central curved battery supports 42b, 48b, 44b, 50b are selected to support batteries of a relatively larger radial dimension, for example standard C and D size single cell batteries.

The first and second bays 28, 30 also include respective regions 52, 54 for receiving a standard 9 volt battery having a generally rectangular shape. As can be seen, the 9 volt batteries are received with their major axes substantially perpendicular to the longitudinal axes of the cylindrical batteries.

Each bay 28, 30 also includes electrical contacts for providing electrical connections to the batteries received therein. Disposed on first end wall 36 are electrical contacts 56a, 56b, 56c associated with the first charging bay 28 and electrical contacts 58a, 58b, 58c associated with the second charging bay 30.

With reference to FIGS. 5 and 7, movable contact supports 64, 66 are associated with the first 28 and second 30 charging bays, respectively. The movable contact supports 64, 66 are longitudinally spaced from the first wall 36. Each contact support 64, 66 is movable in the longitudinal direction so as to accommodate batteries having different longitudinal dimensions. Each movable contact support 64, 66 is preferably spring loaded so that it is urged in the direction of the first wall 36. The movable contact support 64 associated with the first charging bay 28 supports electrical contacts 60a, 60b, 60c. The movable contact support 66 associated with the second charging bay 30 supports electrical contacts 62a, 62b, 62c.

The 9 volt battery receiving region 52 in the first bay 28 also includes contacts 68a, 68b for making electrical contact with a 9 volt battery received therein. Likewise, the 9 volt battery receiving region 54 in the second bay 30 also includes contacts 70a, 70b for making electrical contact with a 9 volt battery received therein.

In use, a user may insert batteries of various sizes into the first and second charging bays 28, 30. With reference to the first charging bay 28, for example, the user may insert two AA size batteries, two AAA batteries, one C size battery, one D size battery, or one 9 volt battery.

In the case of AA or AAA batteries, the first battery is inserted so as to be supported by the left-most battery supports 42a, 48a in the first bay 28. Corresponding electrical contacts 56a, 60a make electrical contact with the positive and negative terminals of the first battery. The second battery is inserted so as to be supported by the right-most battery supports 42c, 48c. Corresponding electrical contacts 56c, 60c make electrical contact with the positive and negative terminals of the second battery.

In the case of C or D batteries, the user inserts a single battery so as to be supported by the inner or central battery support 42b, 48b. Corresponding electrical contacts 56b, 60b make electrical contact with the positive and negative terminals of the battery.

Accordingly, the first bay 28 selectively receives a battery having a relatively larger radial dimension or a plurality of batteries having a relatively smaller radial dimension in positions which are radially offset from that of the larger battery, the larger battery being disposed generally between the smaller batteries.

The position of the movable contact support 64 is longitudinally adjustable to accommodate the longitudinal dimensions of the battery or batteries received in the bay. The contact support 64 is urged in the direction of the first wall 36 so as to make reliable electrical connections with the battery or batteries inserted in the first bay 28.

Alternately, the user may insert a 9 volt battery into the 9 volt battery receiving region 52 of the first bay 28. Corresponding electrical contacts 68a, 68b make electrical contact with the battery terminals.

In the illustrated embodiment, the user may likewise insert batteries of various sizes in the second charging bay 30. For example, the user may insert two AA size batteries, two AAA size batteries, one C size battery, one D size battery, or one 9 volt battery. As illustrated, the choice of battery sizes inserted in the second bay 30 is independent from the battery sizes inserted in the first bay 28.

In the case of AA or AAA batteries, the first battery is inserted so as to be supported by the left-most battery supports 44a, 50a in the second bay 30. Corresponding electrical contacts 58a, 62a make electrical contact with the positive and negative terminals of the first battery. The second battery is inserted so as to be supported by the right most battery supports 44c, 50c. Corresponding electrical contacts 58c, 62c make electrical contact with the positive and negative terminals of the first battery.

In the case of C or D batteries, the user inserts a single battery so as to be supported by the inner or central battery support 44b, 50b. Corresponding electrical contacts 58b, 62b make electrical contact with the positive and negative terminals of the battery.

Accordingly, the second bay 30 selectively receives a battery having a relatively larger radial dimension or a plurality of batteries having a relatively smaller radial dimension in positions which are radially offset from that of the larger battery, the larger battery being disposed generally between the smaller batteries.

The position of the movable contact support 66 is longitudinally adjustable to accommodate the longitudinal dimensions of the battery or batteries received in the bay. The contact support 66 is urged in the direction of the first wall 36 so as to make reliable electrical connections with the battery or batteries inserted in the second bay 30.

Alternately, the user may insert a 9 volt battery into the 9 volt battery receiving region 54 of the second bay 30. Corresponding electrical contacts 70a, 70b make electrical contact with the battery terminals.

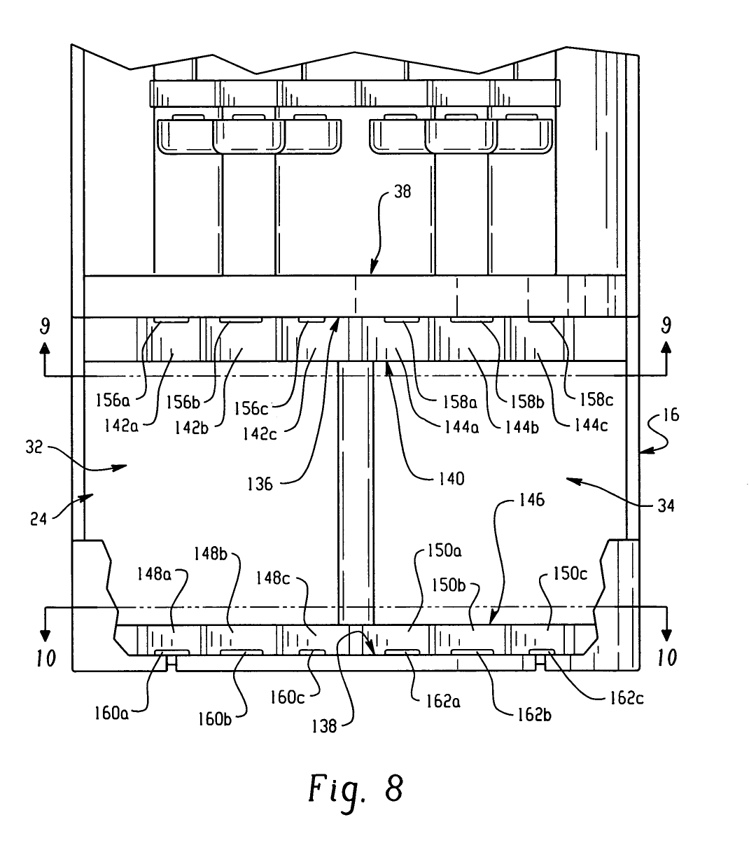

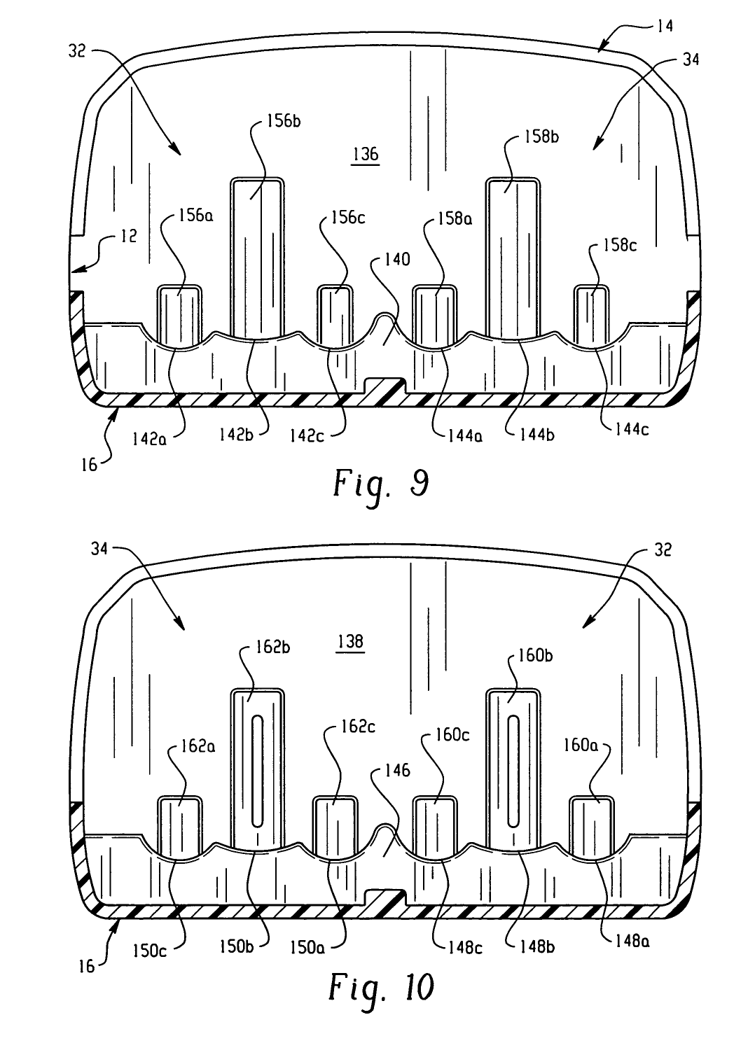

Turning now to FIGS. 4 and 8, the second or auxiliary cavity 24 will be described in greater detail. As noted above, the second cavity 24 includes third and fourth charging bays 32, 34. The third and fourth charging bays 32, 34 are located radially in relation to each other and longitudinally in relation to the first and second charging bays 28, 30.

The second cavity 24 includes first and second end walls 136, 138. The first end wall 136 may advantageously be the outer end wall of the main body 12. The second end wall 138 may advantageously be the inner end wall of the sliding body portion 16. Disposed near the first end wall 136 is a first battery support 140. A second battery support 146 is located near the second end wall 138. The first and second battery supports 140, 146 each include curved battery supports 142a, 142b, 142c and 148a, 148b, 148c associated with the third charging bay 32. The first and second battery supports 140, 146 also include curved battery supports 144a, 144b, 144c and 150a, 150b, 150c associated with the fourth charging bay 34. The radii of the curved battery supports 142a, 142c, 148a, 148c, 144a, 144c, 150a, 150c are selected to support batteries of a relatively smaller radial dimension, for example standard AA and AAA size single cell batteries. The radii of the curved battery supports 142b, 148b, 144b, 150b are selected to support batteries of a relatively larger radial dimension, for example standard C and D size single cell batteries.

Each bay 32, 34 also includes electrical contacts for providing electrical connections to the batteries received therein. Supported by the first end wall 136 are electrical contacts 156a, 156b, 156c associated with the third charging bay 32 and electrical contacts 158a, 158b, 158c associated with the fourth charging bay 34. Supported by the second end wall 138 are electrical contacts 160a, 160b, 160c associated with the third charging bay 32 and electrical contacts 162a, 162b, 162c associated with the fourth charging bay 34.

The movable body portion 16 is movable in the longitudinal direction so as to accommodate batteries 22 having different lengths. The sliding body portion 16 is preferably spring loaded so that the second end wall 138, together with its associated contacts 160, 162 are urged in the direction of the first end wall 136. When no batteries are inserted in the second cavity 24, the sliding body portion 16 is preferably disposable in a retracted position wherein first and second end walls 136, 138 are substantially adjacent.

In use, a user may insert batteries of various sizes into the third and fourth charging bays 32, 34. With reference to the third charging bay 32, for example, the user may insert two AA size batteries, two AAA size batteries, one C size battery, or one D size battery.

In the case of AA or AAA batteries, the first battery is inserted so as to be supported by the left-most battery supports 142a, 148a in the third bay 32. Corresponding electrical contacts 156a, 160a make electrical contact with the positive and negative terminals of the first battery. The second battery is inserted so as to be supported by the right most battery supports 142c, 148c. Corresponding electrical contacts 156c, 160c make electrical contact with the positive and negative terminals of the first battery.

In the case of C or D batteries, the user inserts a single battery so as to be supported by the inner or central battery support 142b, 148b. Corresponding electrical contacts 156b, 160b make electrical contact with the positive and negative terminals of the battery.

Accordingly, the third bay 32 selectively receives a battery having a relatively larger radial dimension or a plurality of batteries having a relatively smaller radial dimension in positions which are radially offset from that of the larger battery, the larger battery being disposed generally between the smaller batteries.

In each case, the position of the movable body portion 16 is longitudinally adjustable to accommodate the longitudinal dimensions of the battery or batteries inserted in the third charging bay 32. The second end wall and hence contacts 160a 160b, 160c are urged in the direction of the first wall 136 so as to make reliable electrical connections with the battery or batteries inserted in the third bay 32.

In the illustrated embodiment, the user may likewise insert a battery or batteries of a corresponding length in the fourth charging bay 34. For example, if the user inserted AA batteries in the third bay 32, additional AA batteries may be inserted in the fourth bay 34. As another example, if the user inserted a C size battery in the fourth bay 34, an additional C size battery may be inserted in the third bay 32. As illustrated, the choice of battery sizes inserted in the third 32 and fourth 34 bays is independent from the battery sizes inserted in the first 28 and second bays 30.

With reference to the fourth bay 34, and in the case of AA or AAA batteries, the first battery is inserted so as to be supported by the left-most battery supports 144a, 150a. Corresponding electrical contacts 158a, 162a make electrical contact with the positive and negative terminals of the first battery. The second battery is inserted so as to be supported by the right most battery supports 144c, 150c. Corresponding electrical contacts 158c, 162c make electrical contact with the positive and negative terminals of the first battery.

In the case of C or D batteries, the user inserts a single battery so as to be supported by the central battery support 144b, 150b. Corresponding electrical contacts 158b, 162b make electrical contact with the positive and negative terminals of the battery.

Accordingly, the fourth bay 34 selectively receives a battery having a relatively larger radial dimension in or a plurality of batteries having a relatively smaller radial dimension in positions which are radially offset from that of the larger battery, the larger battery being disposed generally between the smaller batteries.

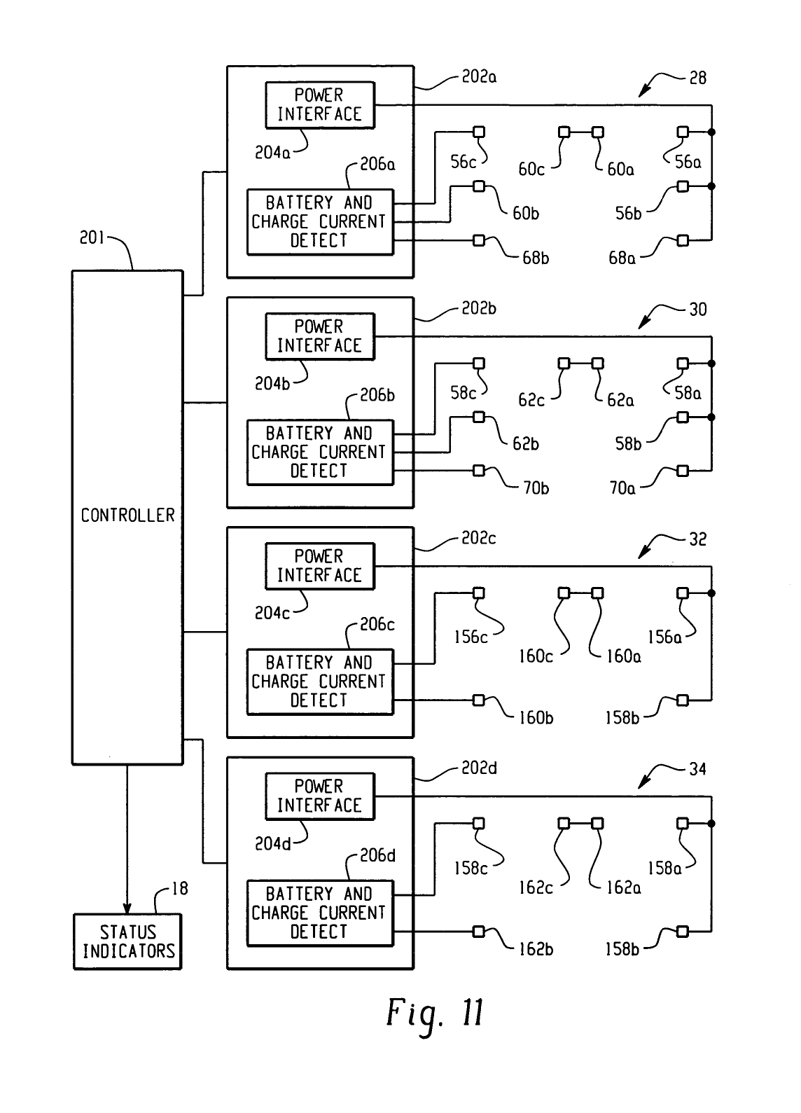

With reference to FIG. 11, electrical charge circuitry provides closed loop control of the current applied to the battery or batteries inserted in the charger 10. The electrical charge circuitry is disposed generally in the electronics region 200 of the main body 12 of the battery charger 10. The charge circuitry receives power from a power source such as an external 12 volt direct current (VDC) source. Alternatively, the charger may also include a power supply which operates from a 120 and/or 240 volt alternating current (Vac) source, or other power source.

The circuitry includes a charger controller 201 which is operatively connected to channel interfaces 202a, 202b, 202c, 202d. Each of the channel interfaces 202a, 202b, 202c, 202d is in turn associated with a corresponding charging bay 28, 30, 32, 34. Each channel interface 202a, 202b, 202c, 202d includes a power interface 204a, 204b, 204c, 204d and battery and charge current detector 206a, 206b, 206c, 206d.

With reference to the channel interface 202a associated with the first charging bay 28, the power interface 204a is electrically connected to the positive battery terminals through contacts 56a, 56b and 68a. The battery charge and current detector 206a is electrically connected to each of the negative battery terminals through contacts 56c, 60b, 68b. Negative battery contact 60a and positive battery contact 60c are electrically connected so that AA or AAA batteries inserted into the first bay 28 are connected electrically in series.

The controller 201 is also operatively connected to the human readable status indicators 18 to indicate the status of the charging.

In operation, battery and charge current detector 206a determines whether AA or AAA batteries, a C or D battery, or a 9 volt battery are installed in the first bay and signals the controller 201 accordingly. The detector 206b also provides the charger controller 201 with a signal indicative of the charging current being applied to the battery (or batteries). The charger controller 201 in turn provides a control signal to the power interface 204a, which applies a corresponding voltage to the battery or batteries inserted in the first bay 28. In this way, the charging electronics provide closed loop control of the current to the battery or batteries.

While the above description has focused on the first charging bay 28, it will be appreciated that the charger controller 201 and channel interfaces 202b, 202c, 202d associated with the second, third and fourth charging bays 28, 30, 32, 34 operate similarly.

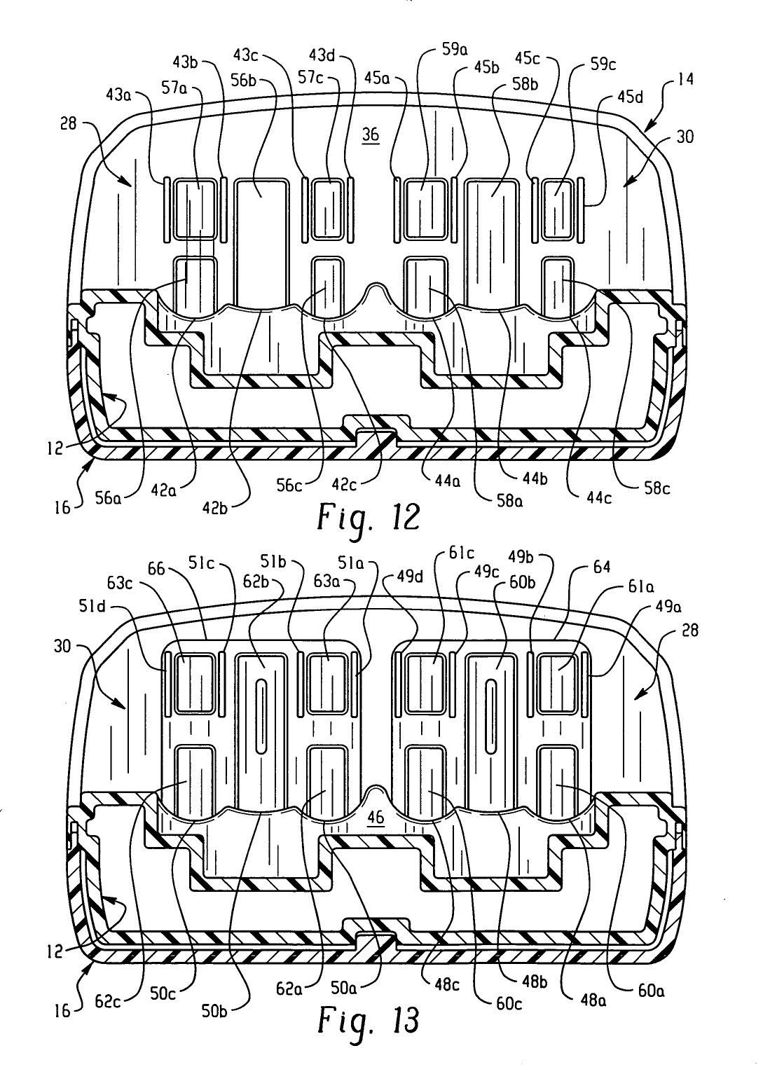

Other variations of the charging bays 28, 30, 32, 34 are also possible. FIGS. 12 and 13, which correspond to the views of FIGS. 5 and 6, depict an exemplary embodiment in which the first and second bays 28, 30 each accept additional third and fourth batteries having relatively smaller radial dimensions. As illustrated, the batteries are received in each of the bays in with their terminals arranged in a generally x-shaped configuration. While the terminal of the relatively larger battery is shown as being at the center of the x, its terminal may also be offset from them. Disposed on first end wall 36 are additional electrical contacts 57a, 57c associated with the first charging bay 28 and additional electrical contacts 59a, 59c associated with the second charging bay 30. The contacts are likewise disposed in a corresponding generally x-shaped configuration.

The movable contact support 64 associated with the first charging bay 28 supports additional electrical contacts 61a, 61c. The movable contact support 66 associated with the second charging bay 30 supports additional electrical contacts 63a, 63c.

Additional battery supports or guides 43a, 43b, 43c, 43d, 45a, 45b, 45c, 45d protrude slightly from the first end wall 36. Additional battery supports or guides 49a, 49b, 49c, 49d, 51a, 51b, 51c, 51d protrude slightly from the first 64 and second 66 contact supports, respectively.

In operation, the user may insert the additional batteries, for example AA or AAA batteries, into each of the bays 28, 30. While the above has focused on the first and second bays 28, 30, the third and fourth bays 32, 34 could be configured analogously. Of course, the electrical charge circuitry would be suitably modified for the additional batteries.

While the electrical appliance has been described in relation to two cavities and four bays, other variations are possible. Thus, for example, the second cavity 24 and hence the third and fourth charging bays 32, 34 can be omitted. Alternately, the second and fourth bays 30, 34 may be omitted while retaining the first and second cavities 20, 24. Still alternately, second cavity 24 could be disposed radially rather than longitudinally in relation to the first cavity 20. The second and fourth bays 30, 34 may also be situated so as to be radially above, rather than next to, the first and third bays 28, 32. Still alternately, additional cavities could be included.

It is also not necessary that the sliding body portion 16 or the first and second contact supports 40, 46 be spring loaded. One or more of them may be motor driven. Manually operated gear mechanisms may also be implemented. Detents which facilitates placement of the respective body portion 16 or support 40, 46 in the desired positions may also be provided.

Moreover, one or more of the charging bays 28, 30, 32, 34 could be modified to accept only a single battery or a more limited range of battery sizes. Thus, for example, a bay or bays could be modified to accept only AA and AAA size batteries or C and D size batteries. In one such embodiment, the second and fourth bays 30, 34, can be omitted. The first and third bays 28, 32 are configured to accept either AA or AAA size batteries. In such an embodiment, the contacts and supports associated with the inner or central battery are omitted. In another such embodiment, the first and third bays are configured to accept only a single battery. In such an embodiment, the outer contacts and supports may be omitted. The bays can be configured to accept a battery of a single size. Alternately, the bays may accept a battery having a range of sizes.

It will also be appreciated that the electrical appliance is not limited to a battery charger. For example, the electrical appliance may include devices that present an electrical load, such as a flashlight, personal electronic device, toy, or the like. Of course, the size and shape of the device would be suitably modified.

In one such embodiment, the electrical appliance may be a flashlight having a generally cylindrical or tubular body. In such a case, the second and fourth bays 30, 34 could be omitted. With a battery or batteries inserted only in the first bay 30, the flashlight would have a relatively compact form factor. The third bay 32 could then be expanded to accept an optional additional battery or batteries. In another variation, the first and third bays 30, 32 could be configured to accept a single battery, for example a D sized battery or alternately a battery having a range of sizes.

In the above description, the AA and AAA batteries have been described as being connected electrically in series. If desired, the contacts can be configured so that the AA and AAA batteries are connected electrically in parallel, either alone or in parallel with the contacts for the C and D cells. Thus, the spaced apart contacts could be visualized as a single electrically connected contact. Alternately, the AA and AAA batteries may be connected to independent channels.

The invention has been described with reference to the preferred embodiments. Of course, modifications and alterations will occur to others upon reading and understanding the preceding description. It is intended that the invention be construed as including all such modifications and alterations insofar as they come within the scope of the appended claims or the equivalents thereof.

What is claimed is:

1. An apparatus comprising:
battery charging circuitry;
a first region adapted to selectively receive one of
a first generally cylindrical battery having a radial dimension; and
a first plurality of generally cylindrical batteries having radial dimensions less than the radial dimension of the first battery, wherein the first plurality of batteries are received in positions which are radially offset from the position of the first battery;
contacts in electrical communication with the battery charging circuitry and adapted to make electrical contact with the batteries selectively received in the first region;
a second region adapted to selectively receive one of
a second generally cylindrical battery having a radial dimension; and
a second plurality of generally cylindrical batteries having radial dimensions less than the radial dimension of the second battery, wherein the second plurality of batteries are received in positions which are radially offset from the position of the second battery;
contacts in electrical communication with the battery charging circuitry and adapted to make electrical contact with the batteries selectively received in the second region.

2. The apparatus of claim 1 wherein the second region is disposed longitudinally in relation to the first region, the apparatus further comprising
a third region disposed radially in relation to the first region and adapted to selectively receive one of
a third generally cylindrical battery having a radial dimension; and
a third plurality of generally cylindrical batteries having radial dimensions less than the radial dimension of the third battery;
contacts in electrical communication with the battery charging circuitry and adapted to make electrical contact with the batteries selectively received in the third region;
a fourth region adapted to selectively receive one of
a fourth generally cylindrical battery having a radial dimension; and
a fourth plurality of generally cylindrical batteries having radial dimensions less than the radial dimension of the fourth battery;
contacts in electrical communication with the battery charging circuitry and adapted to make electrical contact with the batteries selectively received in the fourth region.

3. The apparatus of claim 1 wherein the second region is disposed radially in relation to the first region.

4. The apparatus of claim 1 wherein the first region is adapted to selectively receive one of a C size battery, a plurality of AA size batteries, or a plurality of AAA size batteries.

5. The apparatus of claim 4 wherein the first and second regions are each adapted to selectively receive one of a C size battery, a D size battery, two AA size batteries, or two AAA size batteries.

6. The apparatus of claim 1 wherein the first region is adapted to selectively receive a generally rectangular 9 volt battery.

7. The apparatus of claim 6 wherein the first battery has a longitudinal axis and the generally rectangular 9 volt battery is received with its major axis substantially perpendicular to the longitudinal axis of the first battery.

8. The apparatus of claim 1 wherein the contacts adapted to make electrical contact with batteries selectively received in the first region include longitudinally spaced contacts, wherein the longitudinal spacing of the contacts is adjustable to make electrical contact with batteries having at least first, second, and third longitudinal-dimensions.

9. The apparatus of claim 8 wherein the longitudinal spacing of the contacts is slidably adjustable.

10. The apparatus of claim 8 wherein the contacts adapted to make electrical contact with batteries selectively received in the second region include longitudinally spaced contacts, wherein the longitudinal spacing of the contacts is adjustable to make electrical contact with batteries having at least first, second, and third longitudinal dimensions.

11. The apparatus of claim 10 wherein the longitudinal spacing of the contacts adapted to make electrical contact with batteries selectively received in the first region is adjustable independently from the longitudinal spacing of the contacts adapted to make electrical contact with batteries selectively received in the second region.

12. The apparatus of claim 1 wherein the apparatus is selectively configurable in a first configuration wherein the second region is adapted to receive one or more batteries for charging and a second configuration wherein the second region is substantially non-existent.

13. The apparatus of claim 1 wherein the first region is adapted to selectively receive one of a C size battery, a plurality of AA size batteries, a plurality of AAA size batteries, or a generally rectangular 9 volt battery.

14. An apparatus comprising:
a first set of longitudinally spaced electrical contacts adapted to selectively make electrical contact with the positive and negative terminals of one of
a first generally cylindrical battery having a radial dimension and a longitudinal dimension; and
a first plurality of generally cylindrical batteries having radial dimensions less than the radial dimension of the first battery and longitudinal dimensions different from the longitudinal dimension of the first battery,
wherein the first set of contacts receives the first plurality of batteries in positions which are radially offset from the position of the first battery, and wherein the longitudinal spacing of the first set of electrical contacts is adjustable.

15. The apparatus of claim 14 wherein the first battery comprises a C size battery and the first plurality of batteries comprises AA or AAA size batteries, and wherein the longitudinal spacing of the first set of contacts is adjustable to make electrical contact with C, AA, and AAA size batteries.

16. The apparatus of claim 15 wherein the first plurality equals 2.

17. The apparatus of claim 14 wherein the first battery comprises a C size or a D size battery and the first plurality of batteries comprises AA or AAA size batteries, and wherein the longitudinal spacing of the contacts is selectively adjustable to make electrical contact with the terminals of C, D, AA, and AAA size batteries.

18. The apparatus of claim 14 wherein the first plurality of batteries are connected electrically in series.

19. The apparatus of claim 14 wherein the first set of longitudinally spaced electrical contacts comprises a first contact and a second contact, wherein the apparatus further comprises a first support, wherein the second contact is supported by the first support, and wherein the first support is adjustable so as to vary the longitudinal spacing of the first and second contacts.

20. The apparatus of claim 19 wherein the first support is slidably adjustable.

21. The apparatus of claim 19 wherein the first set of longitudinally spaced electrical contacts comprises a third contact, wherein the third contact is supported by the first support, and wherein the first support is adjustable so as to vary the longitudinal spacing between the first contact and the second and third contacts.

22. The apparatus of claim 19 further comprising:
a second set of longitudinally spaced electrical contacts adapted to selectively make electrical contact with the positive and negative terminals of one of
a second generally cylindrical battery having a radial dimension and a longitudinal dimension; and
a second plurality of generally cylindrical batteries having radial dimensions less than the radial dimension of the second battery and longitudinal dimensions different from the longitudinal dimension of the second battery, wherein the second set of contacts receives the second plurality of batteries in positions radially offset from the position of the second battery, and wherein the longitudinal spacing of the second set of electrical contacts is adjustable.

23. The apparatus of claim 22 wherein the second set of contacts is disposed generally radially in relation to the first set of contacts.

24. The apparatus of claim 22 wherein the second set of longitudinally spaced electrical contacts comprises a fourth contact and a fifth contact, wherein the apparatus further comprises a second support, wherein the fifth contact is supported by the second support, and wherein the second support is adjustable so as to vary the longitudinal spacing between the fourth and fifth contacts.

25. The apparatus of claim 22 wherein the second set of longitudinally spaced electrical contacts comprises a fourth contact and a fifth contact, wherein the fifth contact is supported by the first support, and wherein the first support is adjustable so as to vary the longitudinal spacing between the first and fourth contacts and the second and fifth contacts.

26. The apparatus of claim 14 further comprising battery charging circuitry, wherein the first set of longitudinally spaced contacts is operatively connected to the battery charging circuitry.

27. An apparatus comprising:
at least a first electrical contact for selectively making electrical contact with a first terminal of one of
a first battery having a radial dimension and a longitudinal dimension;
each of a first plurality of batteries having a radial dimension less than the radial dimension of the first battery and a longitudinal dimension different from that of the first battery;
at least a second electrical contact for selectively making electrical contact with the second terminal of one of the first battery and each of the first plurality of batteries, wherein the contacts receive the first plurality of batteries in positions which are generally radially offset from the position of the first battery;
means for supporting the at least a second contact for longitudinal motion in relation to the at least a first contact, wherein the spacing of the contacts is adjustable between a first position for making electrical contact with the terminals of the first battery and a second position for making electrical contact with the terminals of the first plurality of batteries.

28. The apparatus of claim 27 wherein the contacts are adjustable to a third position in which the distance between the contacts is insufficient to receive a battery for electrical contact there between.

29. The apparatus of claim 27 wherein the means for supporting is slidably movable in the longitudinal direction.

30. The apparatus of claim 29 wherein the apparatus comprises a main body portion and wherein the means for supporting comprises a moving body portion.

31. The apparatus of claim 27 further comprising
at least a third electrical contact for selectively making electrical contact with a first terminal of one of
a second battery having a radial dimension and a longitudinal dimension;
each of a second plurality of batteries having a radial dimension less than the radial dimension of the second battery and a longitudinal dimension different from that of the second battery;
at least a fourth electrical contact for selectively making electrical contact with the second terminal of one of the second battery and each of the second plurality of batteries, wherein the contacts receive the second plurality of batteries in positions which are radially offset from the position of the second battery;
means for supporting the at least a fourth contact for longitudinal motion in relation to the at least a third contact, wherein the spacing of the contacts is adjustable between a first position for making electrical contact with the terminals of the second battery and a second position for making electrical contact with the terminals of the second plurality of batteries.

32. The apparatus of claim 27 wherein the first battery comprises C or D size batteries and the first plurality of batteries comprises AA or AAA size batteries, wherein the contacts are adjustable to first, second, third, and fourth longitudinal positions for making electrical contact with the terminals thereof.

33. The apparatus of claim 27 wherein the apparatus further comprises battery charging circuitry in electrical communication with the contacts.

34. An apparatus comprising:
a structure which defines a battery receiving region, the battery receiving region adapted to selectively receive either:
a plurality of AA size batteries;
a plurality of AAA size batteries, or
a first battery having a radial dimension larger than the radial dimension of the AA batteries, wherein the first battery is received in a position which is radially offset from a position of a AA battery received in the battery receiving region;
contacts adapted to make electrical contact with the batteries selectively received in the battery receiving region.

35. The apparatus of claim 34 wherein the battery receiving region is adapted to selectively receive two AA size batteries, two AAA size batteries, a C size battery, or a D size battery.

36. The apparatus of claim 35 wherein the battery receiving region is adapted to receive a generally rectangular 9 volt battery.

37. An apparatus comprising:
a first body portion configured to receive a first generally cylindrical battery, the first body portion having a first wall;
a first pair of longitudinally spaced contacts adapted to make electrical contact with the first battery;
a movable body portion having a second wall, wherein the movable body portion is movable between a first position in which the first and second walls are adjacent to each other and a second position in which the first and second walls are spaced from one other, and wherein the moveable body portion is configured to receive a second generally cylindrical battery;
a second pair of contacts adapted to make electrical contact with the second battery, the second pair of contacts including a first contact supported by the first wall and a second contact supported by the second wall.

38. The apparatus of claim 37 wherein the second battery is received longitudinally in relation to the first battery.

39. The apparatus of claim 37 wherein the first body portion is configured to receive a third generally cylindrical battery, wherein the third battery is received radially in relation to the first battery, and wherein the apparatus further comprises a third pair of contacts adapted to make electrical contact with the third battery.

40. The apparatus of claim 39 wherein the movable body portion, when disposed in the second position, is configured to receive a fourth generally cylindrical battery, wherein the fourth battery is received radially in relation to the third battery, and wherein the apparatus further comprises a fourth pair of contacts adapted to make electrical contact with the fourth battery.

41. The apparatus of claim 37 wherein the spacing between the first pair of contacts is adjustable to make electrical contact with batteries having at least first and second longitudinal dimensions.

42. The apparatus of claim 37 wherein the spacing between the second pair of contacts is adjustable to make electrical contact with batteries having at least first and second longitudinal dimensions.

43. The apparatus of claim 42 wherein the first body portion and the movable body portion are configured to receive at least one of AA, AAA, C, and D size batteries.

44. The apparatus of claim 43 wherein the first body portion is configured to selectively receive one of a first battery having a radial dimension and a plurality of batteries having a second radial dimension, the second radial dimension being smaller than the first radial dimension, and wherein the apparatus further comprises contacts adapted to make electrical contact with the batteries selectively received by the first body member.

45. The apparatus of claim 37 wherein the apparatus further comprises battery charging circuitry in electrical communication with the first and second pairs of contacts.

46. An apparatus of claim 37 wherein the apparatus further comprises a flashlight in electrical communication with the first and second pairs of contacts.

47. The apparatus of claim 37 further comprising a battery support disposed near the second wall.

48. An apparatus comprising:
a first housing portion, the first housing portion defining a first battery holding region adapted to hold a first battery; and
a second housing portion, wherein the second housing portion is extendable in relation to the first housing portion so as to define a second battery holding region adapted to hold a second battery, and wherein the second housing portion is retractable in relation to the first housing portion so that the second battery holding region is substantially non-existent;
a first contact adapted to make electrical contact with the first battery;
a first contact adapted to make electrical contact with the second battery.

49. The apparatus of claim 48 wherein the second housing portion is telescopically extendable.

50. The apparatus of claim 48 wherein the first housing portion includes a first wall and the second housing portion includes a second wall, and wherein the first and second walls are substantially adjacent when the second housing portion is retracted.

51. The apparatus of claim 50 wherein the apparatus further comprises a battery support disposed near the second wall.

52. The apparatus of claim 50 further including a second contact adapted to make electrical contact with the second battery, wherein the first contact adapted to make electrical contact with the second battery is supported by the first wall and the second contact adapted to make electrical contact with the second battery is supported by the second wall.

53. The apparatus of claim 48 wherein the second battery holding region is adapted to hold a plurality of batteries disposed in radial relation to each other and wherein the apparatus further comprises contacts adapted to make electrical contact with the plurality of batteries.

54. The apparatus of claim 53 wherein the second battery holding region is adapted to receive batteries of more than one size.

55. The apparatus of claim 54 wherein the batteries include AA, AAA, C, and D size batteries.

56. The apparatus of claim 48 wherein the second battery holding region is disposed longitudinally in relation to the first battery holding region.

57. The apparatus of claim 48 further comprising battery charging circuitry in electrical communication with the contact adapted to make electrical contact with the first battery and the contact adapted to make electrical contact with the second battery.
